(19) United States
(12) Patent Application Publication
(10) Pub. No.: US 2025/0283736 A1
(43) Pub. Date: Sep. 11, 2025

(54) METHOD FOR MANUFACTURING AN INDUCTIVE SENSOR PROVIDED WITH AN INSERT, AND ASSOCIATED INDUCTIVE SENSOR

(71) Applicant: Schaeffler Technologies AG & Co. KG, Herzogenaurach (FR)

(72) Inventors: Cyrille PATRI, Toulouse (FR); Armand BERNARD, Toulouse (FR); Bertrand PERILLAT, Toulouse (FR)

(21) Appl. No.: 19/070,099

(22) Filed: Mar. 4, 2025

(30) Foreign Application Priority Data
Mar. 5, 2024 (FR) 2402179

(51) Int. Cl. G01D 5/20; G01B 7/30

(52) U.S. Cl. CPC G01D 5/20; G01B 7/30

(57) ABSTRACT

The invention relates to an inductive sensor (100) and its manufacturing method, said sensor having a housing (110) extending in a plane (x, y) with a thickness measured along an axis (z), a printed circuit board (130) and an insert (120), the printed circuit board and the insert superposed on the circuit board both being embedded in a resin in an interior space of said housing, the interior space being defined by a bottom (119) and an outer edge (116), characterized in that the outer edge of said housing has at least one surface (114) bearing against a surface (124) provided on the periphery of the insert, the printed circuit board thus being pressed against the bottom of said housing.

### TECHNICAL FIELD

The present invention relates to an inductive sensor, in particular an angular position sensor, and to a method for manufacturing such a sensor.

### PRIOR ART

It is known from the prior art to use an angular position sensor to detect the speed of rotation of a rotary piece in order to allow electronic processing of information.

When an inductive angular position sensor is used, the rotary piece is equipped with a partially metallized disk. Close to this disk is an oscillating LC (capacitor coil) circuit, the damping of which depends on the distance between the coil L and the metallized zone passed through by the eddy currents generated during the oscillation. Observation of this damping makes it possible to detect the rotation of the rotary piece. The use of a plurality of coils may make it possible, for example, to also detect the direction of rotation of the rotary piece.

Usually, an angular position sensor has a housing that contains an electronic printed circuit board composed mainly of a circular part that bears coils, a set of electronic components and a zone that groups together connection terminals.

Manufacturing methods generally consist in inserting the printed circuit board into the housing and pouring a resin so as to immobilize and protect the printed circuit board.

However, the resin volumes represent significant manufacturing costs.

This is why it proves necessary to reduce the volume of resin consumed, which allows a saving in cost on the one hand and in production time on the other hand, since with a smaller volume of resin, the duration of polymerization decreases accordingly.

Moreover, it is important to position the circular part that bears the coils very precisely, since the reliability of the sensor depends not only on the positioning, but also on the stability of the positioning of the coils.

In other words, it is necessary to ensure that, after resin coating, the coils are immobilized in the housing and that no clearance remains that would make lateral or vertical movements possible.

It is known to use rivets that make it possible to position the printed circuit board in its housing, and to fasten the circuit board definitively by performing heading of these rivets. This fastening is implemented before pouring of the resin.

Nevertheless, such an immobilization process is not entirely satisfactory.

Specifically, the use of rivets at the bottom of the housing weighs down the design and above all induces a very tolerance-sensitive production quality.

An aim of the present invention is also to eliminate the use of these rivets, with, of course, the heading operations.

### DISCLOSURE OF THE INVENTION

To this end, the invention relates to a method for manufacturing an inductive sensor having at least a housing extending in a longitudinal plane (x, y) with a thickness measured along an axis (z) orthogonal to the longitudinal plane, a printed circuit board and an insert, said method involving the following steps:
Positioning the printed circuit board in an interior space of said housing, the interior space being defined by a bottom and an outer edge,
Positioning the insert above the printed circuit board,
Moving the insert so as to bring at least one bearing surface provided on the outer edge of said housing and one bearing surface provided on the periphery of the insert to bear against one another, the printed circuit board thus being pressed by the insert against the bottom of said housing,
Pouring a resin into the interior space of said housing lined with the printed circuit board and the insert,
Polymerization of said resin.

Varied embodiments of the invention are provided, incorporating the various optional features set out below in all of their possible combinations.

According to a particular manufacturing mode, moving the insert bringing at least one bearing surface provided on the outer edge of said housing and one bearing surface provided on the periphery of the insert to bear against one another consists of clip-fastening the insert onto the outer edge of said housing.

According to a manufacturing mode dedicated to an inductive angular position sensor, the insert and a part of the printed circuit board respectively have the shape of a disk hollowed out at its center, a part of the interior space being of substantially complementary shape, the outer edge of the housing having an inner circumferential surface induced by complementarity of shape, and having at least three projecting lugs each bearing a bearing surface, the insert also having at its periphery at least three projecting lugs each bearing a bearing surface.

In this configuration, moving the insert in the longitudinal plane (x, y) consists of rotating the insert on itself about the axis (z) orthogonal to the longitudinal plane, so as to position the at least three lugs of the insert beneath the at least three lugs of the housing, and thus bring the bearing surfaces of said lugs that are respectively provided on the outer edge of the housing and at the periphery of the insert to bear against one another.

Preferentially, the bearing surfaces of the lugs of the housing and of the insert are beveled, so that clamping occurs during the engagement of the bearing surfaces against one another.

Even more preferentially, the bearing surfaces of the lugs of the housing and of the insert are beveled at an angle of between 2 and 15 degrees with respect to the longitudinal plane (x, y).

Advantageously, the housing also has a substantially circular inner edge provided on its outer circumferential surface with protrusions allowing centered positioning of the printed circuit board in the interior space of said housing.

Another subject of the invention is an inductive sensor having at least a housing extending in a longitudinal plane (x, y) with a thickness measured along an axis (z) orthogonal to the longitudinal plane, a printed circuit board and an insert, superposed on the circuit board, the printed circuit board and the insert being situated in an interior space of said housing and both embedded in a resin, said interior space being defined by a bottom and an outer edge, the outer edge of said housing having at least one surface bearing against a surface provided on the periphery of the insert, the printed circuit board thus being pressed by the insert against the bottom of said housing.

Varied embodiments of the invention are provided, incorporating the various optional features set out below in all of their possible combinations.

Advantageously, the printed circuit board is in direct physical contact with the bottom of the housing on the one hand and with the insert on the other hand, the resin furthermore not covering the insert on the side opposite the printed circuit board.

According to one particular embodiment, the insert is clip-fastened onto the outer edge of the housing.

According to another particular embodiment, the inductive sensor is an angular position sensor, the insert and a part of the printed circuit board respectively having the shape of a disk hollowed out at its center, a part of the interior space being of substantially complementary shape, the outer edge of the housing having an inner circumferential surface induced by complementarity of shape, and having at least three projecting lugs each bearing a bearing surface, the insert also having at its periphery at least three projecting lugs each bearing a bearing surface.

According to a preferential aspect of the embodiment mentioned above, the bearing surfaces of the lugs of the housing and of the insert are beveled, so that clamping occurs during the engagement of the bearing surfaces against one another.

According to an even more preferential aspect, the bearing surfaces of the lugs of the housing and of the insert are beveled at an angle of between 2 and 15 degrees with respect to the longitudinal plane (x, y).

According to another advantageous aspect, the housing has a substantially circular inner edge provided on its outer circumferential surface with protrusions allowing centered positioning of the printed circuit board in the interior space of said housing.

### BRIEF DESCRIPTION OF THE FIGURES

The invention will be understood better from reading the following description, which is given solely by way of non-limiting example and with reference to the appended drawings, in which:

FIG. 1 is a schematic depiction of a perspective cross section of an exemplary embodiment according to the invention, which is non-limiting, of an inductive angular position sensor.

FIG. 2 is a schematic perspective depiction of a housing of an exemplary embodiment according to the invention, which is non-limiting, of an inductive angular position sensor.

FIG. 3 is a schematic perspective depiction of a contributory element of an exemplary embodiment according to the invention, which is non-limiting, of an inductive angular position sensor.

FIG. 4 is a schematic perspective depiction of a printed circuit board of an exemplary embodiment according to the invention, which is non-limiting, of an inductive angular position sensor.

FIG. 5 is a schematic perspective depiction of a detail of an exemplary embodiment according to the invention, which is non-limiting, of an inductive angular position sensor.

It will be understood that the embodiments that will be described below are in no way limiting. It will in particular be possible to imagine variants of the invention that comprise only a selection of features described below, isolated from the other described features, if this selection of features is sufficient to confer a technical advantage or to differentiate the invention with respect to the prior art. This selection comprises at least one preferably functional feature without structural details, or with only part of the structural details if it is this part that is solely sufficient to confer a technical advantage or to differentiate the invention with respect to the prior art.

In particular, all the variants and all the embodiments described can be combined with each other if nothing prevents this combination on a technical level.

In the figures and in the rest of the description, elements that are common to several figures retain the same references.

### DETAILED DESCRIPTION OF THE FIGURES

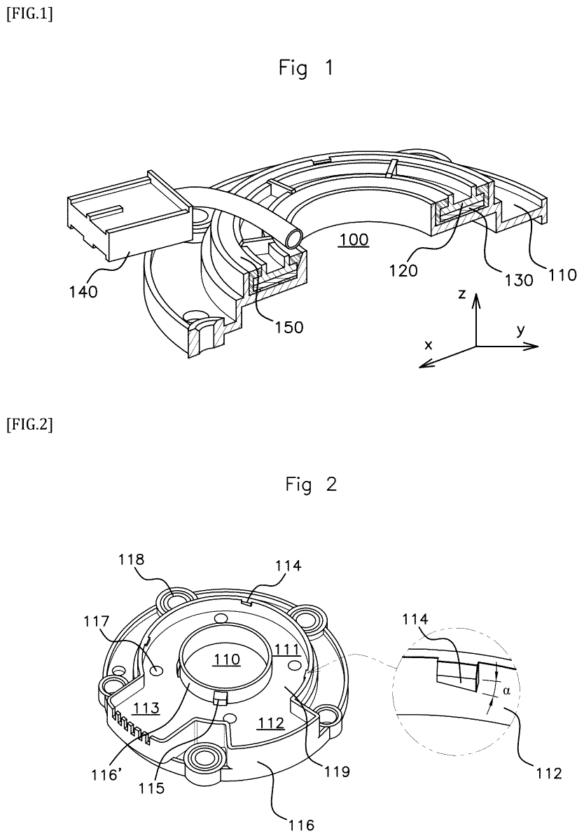

FIG. 1 is a schematic depiction of a perspective cross section of an exemplary embodiment according to the invention, which is non-limiting, of an inductive angular position sensor 100.

The inductive sensor 100 has a housing 110 extending in a plane x, y with a thickness measured along an axis z, a printed circuit board 130 and an insert 120. The printed circuit board and the insert superposed on the circuit board are both embedded in a resin 150 in an interior space of said housing.

FIG. 2 is a schematic perspective depiction of a housing 110 of an exemplary embodiment according to the invention, which is non-limiting, of an inductive angular position sensor.

The interior space of the housing is defined by a bottom 119 and an outer edge 116 and an inner edge 116′. The housing may be made of polyamide or polybutylene terephthalate (PBT). Other materials may also be used.

The bottom is defined as the lower internal surface of the housing and may include possible roughnesses (or pads) 117 and surface topologies. These roughnesses, which generally have a very small height (about 0.2 mm), can be introduced to correct any flatness defect.

In greater detail, the interior space of the housing is compartmentalized according to a hollowed-out disk-shaped part 111 intended to accommodate the portion of the printed circuit board bearing the coils. The interior space of the housing also comprises a zone 112 intended to receive electronic components of the printed circuit board and a zone 113 intended to accommodate the connections of the printed circuit board.

The part 111 of the interior space is of substantially complementary shape to the part of the printed circuit board bearing the coils.

“Complementarity of shape” is understood to mean the fact that two pieces have geometries that are similar to within tolerances of the order of a millimeter around the entire perimeter of the printed circuit board and the insert, so as to allow the coating by the resin.

Specifically, it is important to preserve a clearance during the insertion of the printed circuit board, and then of the insert, into the interior space of the housing, so as to allow them to be coated by resin subsequently.

The outer edge 116 of the housing has in large part an inner circumferential surface induced by complementarity of shape, which has at least three projecting lugs each bearing a bearing surface 114.

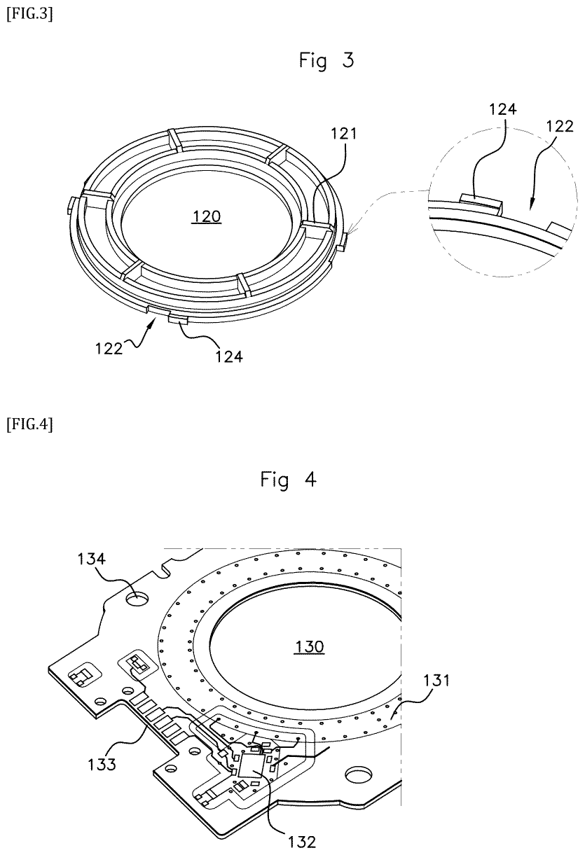

FIG. 3 is a schematic perspective depiction of a contributory element of an exemplary embodiment according to the invention, which is non-limiting, of an inductive angular position sensor.

This element that is contributory to the invention is the insert 120, which has the shape of a disk hollowed out at its center, also of complementary shape to the part 111 of the interior space of the housing. The insert 120 has at its periphery three projecting lugs each bearing a bearing surface 124 shaped to be pressed against one of the bearing surfaces 114 borne by one of the three lugs of the outer edge 116 of the housing.

Translation along the axis (z) of the printed circuit board is thus made impossible.

The periphery of the insert preferably has three notches 122 allowing the insertion of said insert into the hollowed-out disk-shaped part 111 of the housing at the three lugs provided on the outer edge 116.

Preferably, the three lugs of the outer edge 116 of the housing, just like the three lugs at the periphery of the insert, are distributed in a balanced manner, in the sense that they are distributed at an angle of the order of 120 degrees each time.

FIG. 4 is a schematic perspective depiction of a printed circuit board of an exemplary embodiment according to the invention, which is non-limiting, of an inductive angular position sensor.

The printed circuit board 130 comprises a portion 131 provided with coils, a set 132 of electronic components and connections 133. The portion 131 has the shape of a disk hollowed out at its center.

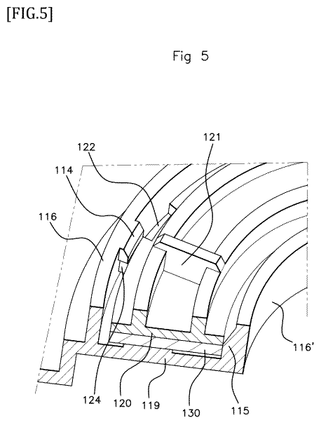

FIG. 5 is a schematic perspective depiction of a detail of an exemplary embodiment according to the invention, which is non-limiting, of an inductive angular position sensor.

In this figure and in accordance with the principle of the invention, it can be seen that the bearing surfaces 114 provided on the lugs of the edge 116 of the housing are pressed against the bearing surfaces 124 provided on the lugs of the insert 120.

Of course, other variants of the invention are entirely conceivable.

Thus, it is possible to envisage a plurality of four or more lugs provided both on the edge 116 of the housing and at the periphery of the insert 120.

It is also possible to envisage, instead of the lugs, one or more circular ribs provided both on the inner circumferential surface of the edge 116 of the housing and at the periphery of the insert 120.

The invention can also be applied not only to inductive angular position sensors, but also to linear inductive sensors.

In this application, which is not shown in the figures, the interior space of the housing is compartmentalized according to a rectangular part intended to accommodate the portion of the printed circuit board bearing the coils. The interior space of the housing also comprises a zone intended to accommodate electronic components of the printed circuit board and a zone intended to accommodate the connections of the printed circuit board.

The insert and the portion of the printed circuit board bearing the coils also have a rectangular shape complementary to that of the housing.

In accordance with the invention, the outer edge of the housing has at least one provided bearing surface, provided to be pressed against a bearing surface provided on the periphery of the insert.

These bearing surfaces may be borne by projecting lugs or continuous or else non-continuous ribs provided respectively on the edge of the housing and at the periphery of the insert.

According to an improvement of the invention that is applicable both to linear inductive sensors and to inductive angular position sensors, the bearing surfaces 114, 124 of the housing and of the insert are beveled, so that clamping occurs during the engagement of the bearing surfaces 114, 124 against one another.

Advantageously, and as shown in the enlargement inset in FIG. 2 and FIG. 3, the bearing surfaces 114, 124 of the lugs of the housing and of the insert are beveled, at an angle of between 2 and 15 degrees, with respect to the longitudinal plane (x, y), and preferentially of the order of 5 degrees.

This makes it possible to ensure sufficient clamping, overcoming the effect of the tolerances of each of the pieces, while at the same time keeping the force necessary for the clamping within reasonable limits.

According to an improvement of the invention that is applicable in particular to inductive angular position sensors and shown in FIG. 2, the housing has a substantially circular inner edge 116′ provided on its outer circumferential surface with protrusions 115 allowing centered positioning of the printed circuit board in the interior space of said housing.

Now with regard to the method for manufacturing an inductive sensor 100, whether of the linear or angular position type, as described above, first of all a step of positioning the printed circuit board in an interior space of said housing is carried out.

Then the insert is positioned on the printed circuit board.

Next, the insert is set in motion in the plane x, y so as to bring the at least one (preferably at least two) bearing surface 114 provided on the outer edge of said housing and the at least one (preferably at least two) bearing surface 124 provided on the periphery of the insert to bear against one another.

Thus, the printed circuit board is pressed against the bottom of said housing.

Finally, a resin is poured into the interior space of said housing lined with the printed circuit board and the insert.

This resin may be an epoxy resin.

It is recalled that “complementarity of shape” is understood to mean the fact that two pieces have geometries that are similar to within tolerances of the order of a millimeter around the entire perimeter of the printed circuit board and the insert.

Specifically, it is important to preserve a clearance during the insertion of the printed circuit board, and then of the insert, into the interior space of the housing, so as to allow them to be coated by resin.

A step of polymerization of said resin makes it possible to seal the assembly definitively.

In the case in which the inductive sensor is an angular position sensor, of the type as described above, i.e. having an insert 120 and a part 131 of the printed circuit board 130 respectively having the shape of a disk hollowed out at its center, a housing 110 with a part 111 of the interior space of substantially complementary shape, the outer edge 116 of the housing having, for example, one or more projecting lugs (or ribs) each bearing a bearing surface 114, the insert also having at its periphery one or more projecting lugs (or ribs) each bearing a bearing surface 124, the step of moving the insert in the plane x, y consists of rotating the insert on itself about the axis z.

As a result of this rotation, the lugs of the insert (or ribs) are positioned beneath the corresponding lugs (or ribs) of the housing, and the bearing surfaces 114, 124 of the lugs (or ribs) are brought to bear against one another.

Translation along the axis (z) of the printed circuit board is thus made impossible.

In the improvement according to which the bearing surfaces 114, 124 of the lugs (or ribs) of the housing and of the insert are beveled, clamping occurs during the engagement of the bearing surfaces 114, 124 against one another.

The rotation and subsequent clamping are delimited by the slope defined by the beveled surfaces. This slope has an angle of between 2 and 15 degrees with respect to the longitudinal plane (x, y), and preferentially an angle of the order of 5 degrees.

A good compromise is thus obtained between sufficient clamping, which maintains the position of the printed circuit board pressed on the bottom of the housing, and an admissible clamping force. “Admissible clamping force” is understood to mean a force that can be applied by an operator on a production line, or else a force applied by a robot without damaging the structure of the housing and the insert.

The insert may advantageously have gripping means 121 on its outer face so as to make it easier to set in motion (rotation in the case of an inductive angular position sensor or translation in the case of a linear inductive sensor).

Advantageously, the positioning of the printed circuit board in an interior space of said housing is accompanied by centering of said circuit board in said housing.

To this end, the housing may have a substantially circular inner edge 116′ advantageously provided on its outer circumferential surface with protrusions 115 allowing centered positioning of the printed circuit board in the interior space of said housing. Some of them may have an elastic effect in order to block the movements of the printed circuit board in the plane (x, y).

In the case now in which the inductive sensor is a linear sensor, moving the insert consists of a translational movement in the plane (x, y) so as to slide the lugs (or ribs) of the insert beneath the lugs (or ribs) of the outer edge of the housing.

Of course, the invention is not limited to the examples that have just been described.

It would for example be possible, in the case of an inductive angular position sensor, to provide lugs (or ribs) on the inner edge of the housing, and corresponding lugs (or ribs) on the periphery of the recess of the insert.

It will thus be understood that the invention makes it possible to eliminate the use of the rivets that require not only operations 134 of piercing the printed circuit board but also heading, or riveting, operations, during which rivets protruding from the bottom of the housing are passed through respective openings pierced in the printed circuit board and then deformed to prevent any movement for removal of the printed circuit board.

The invention makes it possible to reliably immobilize the printed circuit board in the housing before pouring the resin.

It will also be understood that the invention also makes it possible to reduce the volume of resin consumed, which allows a saving in cost on the one hand and in production time on the other hand, since with a smaller volume of resin, the duration of polymerization decreases accordingly.

Depending on the dimensioning of the insert adopted, it is specifically possible to achieve reductions in resin volumes of up to 50%.

1. A method for manufacturing an inductive sensor (100) having a housing (110) extending in a longitudinal plane (x, y) with a thickness measured along an axis (z) orthogonal to the longitudinal plane, a printed circuit board (130) and an insert (120), characterized in that it involves the following steps:
Positioning the printed circuit board in an interior space of said housing, the interior space being defined by a bottom (119) and an outer edge (116) of said housing,
Positioning the insert (120) on the printed circuit board,
Moving the insert (120) so as to bring at least one bearing surface (114) provided on the outer edge (116) of said housing and one bearing surface (124) provided on the periphery of the insert to bear against one another, the printed circuit board thus being pressed by the insert (120) against the bottom of said housing,
Pouring a resin into the interior space of said housing lined with the printed circuit board and the insert,
Polymerization of said resin.

2. The method as claimed in claim 1, wherein moving the insert (120) bringing at least one bearing surface (114) provided on the outer edge (116) of said housing and one bearing surface (124) provided on the periphery of the insert to bear against one another consists of clip-fastening the insert (120) onto the outer edge (116) of said housing.

3. The method as claimed in claim 1, wherein the inductive sensor (100) is an angular position sensor, the insert (120) and a part (131) of the printed circuit board (130) respectively having the shape of a disk hollowed out at its center, a part (111) of the interior space being of substantially complementary shape, the outer edge (116) of the housing having an inner circumferential surface induced by complementarity of shape, which has at least three projecting lugs each bearing a bearing surface (114), the insert (120) also having at its periphery at least three projecting lugs each bearing a bearing surface (124), characterized in that:
the step of moving the insert (120) consists of rotating the insert on itself about the axis (z) orthogonal to the longitudinal plane, so as to position the at least three lugs of the insert beneath the lugs of the housing, and thus bring the respective bearing surfaces (114, 124) of the lugs to bear against one another.

4. The method as claimed in claim 3, wherein the bearing surfaces (114, 124) of the lugs of the housing and of the insert are beveled, so that clamping occurs during the engagement of the bearing surfaces (114, 124) against one another.

5. The method as claimed in claim 4, wherein the bearing surfaces (114, 124) of the lugs of the housing and of the insert are beveled, at an angle of between 2 and 15 degrees, with respect to the longitudinal plane (x, y).

6. The method as claimed in claim 3, wherein the housing has a substantially circular inner edge (116′) provided on its outer circumferential surface with protrusions (115) allowing centered positioning of the printed circuit board (130) in the interior space of said housing.

7. An inductive sensor (100) having a housing (110) extending in a longitudinal plane (x, y) with a thickness measured along an axis (z) orthogonal to the longitudinal plane, a printed circuit board (130) and an insert (120), superposed on the circuit board, the printed circuit board and the insert being situated in an interior space of said housing and embedded in a resin, said interior space being defined by a bottom (119) and an outer edge (116), characterized in that the outer edge of said housing has at least one surface (114) bearing against a surface (124) provided on the periphery of the insert, the printed circuit board thus being pressed by the insert (120) against the bottom of said housing.

8. The inductive sensor as claimed in claim 7, characterized in that the printed circuit board (130) is in direct physical contact with the bottom (119) of the housing on the one hand and with the insert (120) on the other hand, the resin furthermore not covering the insert on the side opposite the printed circuit board.

9. The inductive sensor as claimed in claim 7, characterized in that the insert (120) is clip-fastened onto the outer edge (116) of the housing.

10. The inductive sensor as claimed in claim 7, characterized in that the inductive sensor (100) is an angular position sensor, the insert (120) and a part (131) of the printed circuit board (130) respectively having the shape of a disk hollowed out at its center, a part (111) of the interior space being of substantially complementary shape, the outer edge (116) of the housing having an inner circumferential surface induced by complementarity of shape, which has at least three projecting lugs each bearing a bearing surface (114), the insert also having at its periphery at least three projecting lugs each bearing a bearing surface (124).

11. The inductive sensor as claimed in claim 10, wherein the bearing surfaces (114, 124) of the lugs of the housing and of the insert are beveled, so that clamping occurs during the engagement of the bearing surfaces (114, 124) against one another.

12. The inductive sensor as claimed in claim 11, wherein the bearing surfaces (114, 124) of the lugs of the housing and of the insert are beveled, at an angle of between 2 and 15 degrees, with respect to the longitudinal plane (x, y).

13. The inductive sensor as claimed in claim 10, wherein the housing has a substantially circular inner edge (116′) provided on its outer circumferential surface with protrusions (115) allowing centered positioning of the printed circuit board in the interior space of said housing.
